(19) United States
(12) Patent Application Publication
(10) Pub. No.: US 2016/0230421 A1
(43) Pub. Date: Aug. 11, 2016

(54) Timed unlocking and locking mailbox system

(71) Applicant: Stanley Clay Cochran, Bluefield, VA (US)

(72) Inventor: Stanley Clay Cochran, Bluefield, VA (US)

(21) Appl. No.: 14/973,680

(22) Filed: Dec. 17, 2015

Related U.S. Application Data
(60) Provisional application No. 62/125,937, filed on Feb. 5, 2015.

(51) Int. Cl. E05B 43/00; A47G 29/122; G07C 9/00; A47G 29/124

(52) U.S. Cl. CPC E05B 43/005; A47G 29/124; A47G 29/1209; G07C 9/00174

(57) ABSTRACT

A timed unlocking and locking mailbox system to unlock and lock a mailbox at a predetermined, user or factory preset, and repeatable time, every day in order to control when mail can be accessed or deposited. This system is composed of a timing module that uses a micro-controller to time when to actuate an electric locking bar. The timing module and lock are powered by a solar panel and rechargeable batteries.

### CROSS-REFERENCE TO RELATED APPLICATION

This application claims priority from U.S. provisional patent application Ser. No. 62/125,937 filed Feb. 5, 2015, which is incorporated herein by reference.

### FIELD OF THE INVENTION

The invention relates to mailboxes, and more specifically, timed mailboxes that offer people more security over when their mailbox can be accessed.

### BACKGROUND OF THE INVENTION

People often wish to put their out-going mail in the mailbox at night in order to catch an early running mailman. Perhaps these people work night shift or sleep late in the mornings. Theft is a big worry when putting ones mail out at night. Often rural people, who don't have locks on their mail box, have to just put their mail out and hope it isn't stolen or drive to the post office to drop it into a postal slot, which is such a hassle.

Previous mailbox security solutions seem to revolve around some sort of alarm system or two-way communication device to alert the mailbox owner when their mailbox is opened with mail being removed or received. These methods are just overly complicating a simple problem, which my Timed Unlocking and Locking Mailbox System solves. Previous patents, that are no longer current, have also used parts like solar panels and electronics in their construction so nothing is new there.

### SUMMARY

This unique Timed Unlocking and Locking Mailbox System solves mailbox security issues by unlocking a mailbox at a set time in the morning when criminals are less likely to be stealing mail; however, before the mail delivery person has run, and optionally locking back as soon as mail has been delivered, or at a set time later.

### DRAWINGS

FIG. 1 is an angled view, showing the Timed Unlocking and Locking Mailbox System 1, and it's parts, which is composed of the solar panel 2, timing module 3, latch sensor 4, and the electric locking bar 5. FIG. 2 is a semi-frontal view showing the door closed and pointing out the external key lock 6.

### DETAILED DESCRIPTION

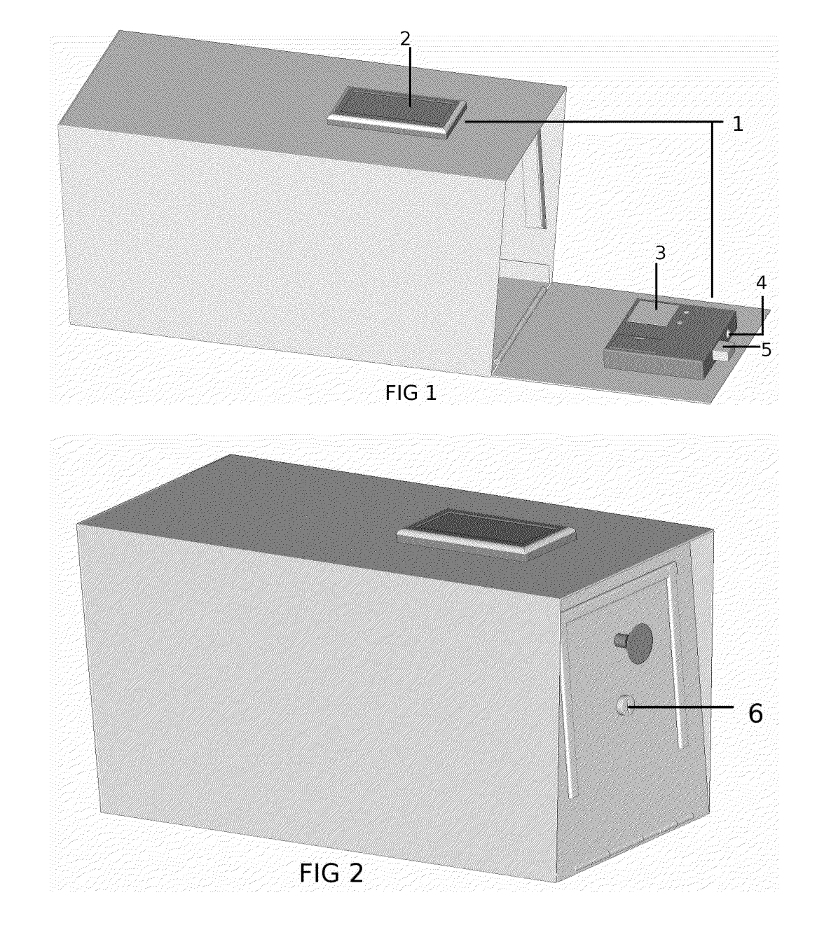

The Timed Unlocking and Locking Mailbox System consists of a solar panel located on top of the mailbox, a timing module, electric locking bar, and latch sensor, hidden inside of the mailbox and shown in FIG. 1. The timed unlocking and locking mailbox system could come with the sale of a new mailbox, as an integrated system, or as an after-market add-on. The timing module is powered by an external solar panel, attached to the top of the mailbox, and rechargeable batteries. The timing module is electronic, using a micro-controller, as that is the most efficient way of implementing this system; however, one could also use a mechanical timer to unlock a mailbox at a specific time if one chose to do so. Another odd way of timing the unlocking of a mailbox, in the morning, would be to detect the rise of the sun with a light detecting sensor; however, this would not work as well on cloudy days or in areas of the world that have 24 hours of sun during different parts of the year.

The timing module, in FIG. 1, will have to be set by the user, through the use of select and set buttons, with the current time of day, the time for the mailbox to be unlocked, and in case one doesn't want the mailbox to re-lock after the door has been opened once and closed again by the mailman, a time to re-lock, probably in the evening at the latest one has seen the mailman run. Access to the mailbox, by the user, during locked periods can be obtained with the use of a key and an external key lock interface on the front of the door, shown in FIG. 2. This allows the user to put his/her mail in the mailbox at night or change the timing module settings while the electronic lock is currently engaged.

After all the perimeters of the timing module have been set, the time to unlock will eventually correspond with the user preset current time, and a micro-controller, in the timing module, will actuate an electric actuated locking bar, on the mailbox door, unlocking the the mailbox door by moving the locking bar, shown in FIG. 1. If the user has selected the option, on the timing module, to lock upon being closed by the mail man, the latch sensor will detect the door closer and actuate the electric lock, re-locking the mailbox; otherwise the timing module will be tripped by the re-locking time preset by the user when it eventually corresponds with the user set current time.

This is really the perfect mailbox security system for anyone who works late at night, and sleeps late in the mornings. It offers a useful amount of protection from theft without the hassle of driving ones mail to the post office or giving ones mailman a key to the mailbox, and hoping he/she doesn't lose it.

I claim:

1. A Timed Unlocking and Locking Mailbox System for receiving and securing mail, comprising:
A Timed Unlocking and Locking Mailbox System to unlock and lock a mailbox at a predetermined, user or factory preset, and repeatable time, every day,
(a) that is integrated with a new mailbox or sold as an after-market add-on for existing mailboxes,
(b) that can be made to work electronically, mechanically, or detect light to time when to unlock or lock a mailbox,
(c) that can optionally lock after detecting the mailbox door has been re-closed instead of waiting for the preset re-lock time.
